(19) United States
(12) Patent Application Publication
(10) Pub. No.: US 2022/0335504 A1
(43) Pub. Date: Oct. 20, 2022

(54) SYSTEM FOR FACILITATING COOPERATIVE COMMERCIAL TRANSACTIONS INVOLVING MULTIPLE PARTIES

(71) Applicant: Target Brands, Inc., Minneapolis, MN (US)

(72) Inventors: Roberto DeVet, Minneapolis, MN (US); Toni Ghilani, Minneapolis, MN (US); Anjolika Bhadra-Dave, Minneapolis, MN (US); Tyler Larson, Minneapolis, MN (US); Ted Nelson, Minneapolis, MN (US); Logan Wilberts, Minneapolis, MN (US); Jathin Jayan, Minneapolis, MN (US)

(21) Appl. No.: 17/719,987

(22) Filed: Apr. 13, 2022

Related U.S. Application Data
(60) Provisional application No. 63/175,932, filed on Apr. 16, 2021.

(51) Int. Cl. G06Q 30/06; G06Q 10/08

(52) U.S. Cl. CPC G06Q 30/0637; G06Q 10/087

(57) ABSTRACT

A network based order fulfillment system having an improved user interface at devices associated with multiple customers collaborating to place and pick up an order with a retailer. The system allows users of multiple devices to coordinate fulfillment of an order through communication with one or more user devices located at a fulfillment location to fulfill orders placed by users of other user devices. An alternate pickup person having a first user device can be associated with an order placed by a different user having a different user device. The user who placed the order can provide identifying information for the alternate pickup person to authorize the alternate pickup person to pick up the order.

### CROSS-REFERENCE TO RELATED APPLICATIONS

This application claims the benefit of U.S. Patent Application Ser. No. 63/175,932, filed on Apr. 16, 2021. The disclosure of the prior application is considered part of (and is incorporated by reference in) the disclosure of this application.

### TECHNICAL FIELD

This document generally relates to architecture of computer systems, communications between computing devices, and graphic user interfaces for eliciting user input.

### BACKGROUND

Computing devices are devices that accept data input, process the data, and provide data output using hardware and software. Computing devices can communicate with other computing devices using wired or wireless networks or a combination thereof. For example, computing devices can communicate over the Internet. User interactions with a computing device can cause the computing device to transmit communications to a second computing device, which can cause the second computing device to provide output such as changes to a visual display, sounds, or tactile output. Such output at the second computing device can elicit user input from a user of the second computing device which can in turn cause the second computing device to transmit one or more communications to the first computing device and/or additional computing devices thereby causing the first computing device and/or or the additional computing devices to generate additional output.

### SUMMARY

This document generally describes a network based order fulfillment systems that provides information to one or more user devices that allow users of multiple user devices to coordinate fulfillment of an order through communication with one or more user devices located at a fulfillment location (such as a physical store location, a restaurant, a warehouse, or other location) to fulfill orders placed by users of other user devices. For example, a first user device can collect user input and other information via a user interface of the first user device and/or one or more sensors of the user device to identify items that a first user wishes to purchase from a store, payment information, and order fulfillment parameters. This information can be used to submit an order for the identified items to a computing system associated with a merchant. The first user's device can communicate with a user device of a second user, such as a friend or relative of the first user, that conveys sufficient information to allow the second user to complete fulfillment of the order, such as by picking up the order from a fulfillment location associated with the merchant (e.g., “curb side”, “drive up” or “in-store” pickup of the order at a brick and mortar store).

A worker at a fulfillment location (e.g., a physical store) can receive information about the order on a user device to allow the worker to fulfill the order in a timely manner and provide the items in the order to the second user upon arrival of the second user at the fulfillment location. The worker can interact with her user device to cause the worker's device to update a status of the order and provide information to the first user's device and or the second user's device which can cause the first user's device to provide additional information to the first user and/or the second user's device to provide additional information to the second user regarding status of the order, changes to items included in the order, and information related to fulfillment/pick up of the order. In one aspect, the second user's device can provide a user interface that includes a unique optically recognizable code (e.g., a barcode or a matrix barcode) that can be used to verify that the second user is authorized to pick up the order. The optically recognizable code can also be used to verify information associated with the order such as order number, information associated with the first user, or information associated with the second user. The second user's device can provide instructions to the second user for scanning, or otherwise verifying, the optically recognizable code. The worker can then use her device to scan the optically recognizable code displayed by the second user's device to verify that the second user is authorized to pick up the order, such as by verifying the second user's identity or an aspect of the order.

In some aspects, the first user's device communicates with the second user's device by transmitting an invitation to the second user to become a shopping partner associated with the first user. In some implementations, this communication is indirect. For example, the first user can interact with a user interface at the first user's device to cause the first user's device to communicate with a server system associated with a merchant to cause the server system to send a message to the second user's device inviting the second user to become a shopping partner of the first user. For example, the first user's device initiate transmission (e.g., by the server system) of a text message (e.g., an SMS message or instant message) to the second user's device inviting the second user to become a shopping partner with the first user. The text message can include, for example, a user selectable link that, when selected by the second user grants the second user permission to pick up an order placed by the first user. In some cases, the second user can be granted permission to pick up a specific order designated by the first user, all orders placed by the first user during a set time period, all orders placed by the first user until the first user rescinds permission, or a set of orders designated by the first user. As another example, the first user's device can initiate transmission of an email message (e.g., by the server system) to an email account of the second user. The second user can access the email on the second user's device to receive authorization to pick up the placed order. The email can include, for example, a user selectable link that, when selected by the second user grants the second user permission to pick up an order placed by the first user. As yet another example, the message initiated by the first user's device and sent to the second user's device can be sent via a proprietary application. For example, the first user and/or the second user can have an application associated with the merchant on their respective devices. The first user can use the application installed on his device to initiate transmission of a message to the second user that gives the second user authorization to pick up the order. The second user can log into a version of the application installed on her device to view information associated with the order. The application installed on the second user's device can also display a scanable code that can be used to verify that the second user is authorized to pick up the order.

In another aspect, information collected at the second user's device (e.g., from user input or via a location detection unit such as a GPS unit of the user's device) can be transmitted to the worker's device to cause the worker's device to provide an indication that the second user has begun to travel to the fulfillment location. The worker's device can also display an estimated arrival time or estimated time until arrival at the fulfillment location for the second user. For example, the second user's device can determine that the second user has begun to travel to the fulfillment location. The second user's device can transmit a communication to the worker's device indicating that the second user has begun traveling to the fulfillment location. The worker's device can provide an estimated time until arrival at the fulfillment location for the second user. Upon the second user arriving at or near the fulfillment location, the second user's device can transmit a communication to the worker's device indicating that the user has arrived. 1 0 In some implementations, this can cause the worker's device to display a count up timer indicating how long the second user has been waiting for the order after arriving at the fulfillment location. In some implementations, if the count up timer reaches a preset threshold, a customized notification can be provided to the first user's device and/or the second user's device to indicate a status of the order, indicate additional instructions for the second user, or communicate another message to the first or second user.

In another aspect, a user interface provided at the first user's device can provide one or more controls for altering aspects of an order after the first user has placed the order. For example, the user interface can allow the first user to add additional items to the order, remove items from the order, add the second user as an authorized pickup person for the order, or add one or more additional people as authorized pickup persons for the order. As another example, the user interface can allow the first user to indicate substitute items for items from the original order that are not available. As another example, the user interface can allow the first user to switch the order type from a drive-up type order to an in-store pick up order. As another example, the user interface can allow the first user to remove people from the list of authorized pickup persons. For example, the first user can remove the second user from the list of authorized pickup persons, after having previous designating the second user as an authorized pickup person.

In one aspect, in general, a method includes receiving, by at one or more computing devices, a first communication including information for an order for fulfillment at a physical location, the information for the order including indications of one or more items and identifying information for a first user; receiving, by the one or 1 0 more computing devices, information including identifying information for an alternate pickup person to be associated with the order, the identifying information for the alternate pickup person having been provided by the first user; associating an identifier for the alternate pickup person with an electronic record for the order; transmitting a communication to the alternate pickup person, the communication including information indicating that the first user has authorized the alternate pickup person to pick up the order; receiving, from a computing device operated by an employee of the physical location, information for verifying the alternate pickup person, the information provided by the computing device associated with the alternate pickup person retrieving order information for the order in response to receiving the information for verifying the alternate pickup person; transmitting the retrieved order information to the computing device operated by the employee of the physical location.

In some aspects, the method further includes using the identifying information for the alternate pickup person provided by the first user to identify a profile for the alternate pickup person, the profile being a profile associated with a retailer associated with the physical location; retrieving a unique identifier for the alternate pickup person from the profile for the alternate pickup person; entering the unique identifier for the alternate pickup person into an “alternate pickup person” field within the electronic record for the order. In some aspects, the electronic record for the order includes a field for an order identifier, a field for an order owner identifier, and at least one field for an alternate pickup person identifier. In some aspects, the computing device operated by the employee of the physical location receives the information for verifying the alternate pickup person by scanning an optically readable code displayed by the computing device associated with the alternate pickup person.

In some aspects, the method further includes, prior to receiving the information for verifying the alternate pickup person, providing information to the computing device associated with the alternate pickup person that allows the computing device associated with the alternate pickup person to display the optically readable code. In some aspects, the method further includes, in response to retrieving the order information for the order, transmitting information to the computing device operated by the employee of the physical location indicating that the alternate pickup person is authorized to pick up the order. In some aspects, the information for verifying the alternate pickup person comprises a unique identifier for the alternate pickup person.

In some aspects, the method further includes retrieving second order information for a second order placed by the alternate pickup person in response to receiving the information for verifying the alternate pickup person; and transmitting the retrieved second order information to the computing device operated by the employee of the physical location.

The systems, devices, program products, and processes described throughout this document can, in some instances, provide one or more of the following advantages. By providing streamlined communications between mobile devices operated by users/customers (including alternate pickup persons) and employees working at fulfillment locations, an order fulfillment system can reduce the amount of time spent interacting with the mobile devices, thereby reducing power consumption and improving battery life of the computing devices. Additionally, by streamlining communications 1 0 while providing for computer network based ordering and pick-up facilitation, the computing system can reduce the amount of communications to and from mobile computing devices, thereby reducing bandwidth usage of one or more communications networks and freeing up communications bandwidth for other purposes. Additionally, unique user interface elements at mobile computing devices of both users/customers (including alternate pickup persons) and employees of fulfillment locations can improve user experience thereby leading to improved outcomes with respect to efficiency and accuracy of both user interactions with the mobile computing devices and fulfillment of orders. Other benefits and advantages will be apparent from the following descriptions.

### DESCRIPTION OF DRAWINGS

FIG. 1 is diagram of an example system for facilitating alternate pickup person order fulfillment.

FIGS. 2A-2G show example user interface displays a first computing device in an alternate pickup person order fulfillment system.

FIGS. 3A-3F show example user interface displays a second computing device in an alternate pickup person order fulfillment system

FIG. 4 is a flowchart of an example process to be performed by a computing device in an alternate pickup person order fulfillment system.

FIG. 5 is a schematic diagram that shows an example of a computing system.

Like reference symbols in the various drawings indicate like elements.

### DETAILED DESCRIPTION

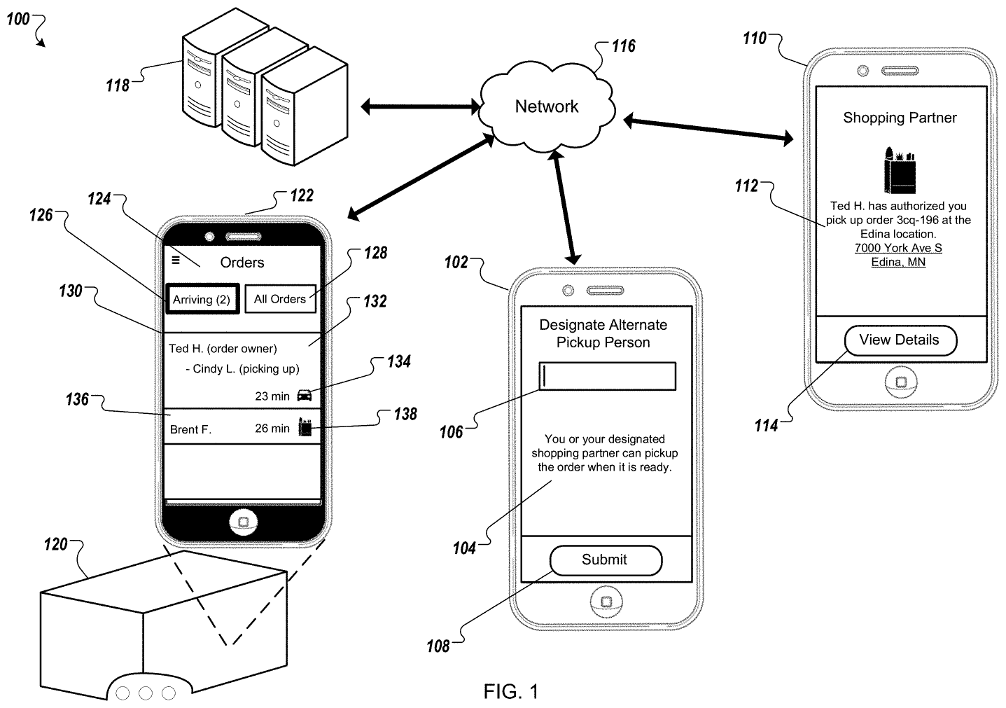

FIG. 1 is a diagram of an example system 100 for facilitating order fulfillment for order pickup by an authorized alternate pickup shopping partner. In the system 100, a first user, such as a customer who wishes to place an online order for items for pickup at a fulfillment location (such as a store, restaurant, or warehouse), can access a dedicated application executing on a mobile device 102. The mobile device 102 can be, for example, a mobile phone, a tablet device, a touch screen computer, a laptop computer, a PDA, a smart watch, or other mobile device. In some implementations, a non-mobile computing device, such as a desktop computer or smart television, performs the functions described with respect to the mobile device 102 and therefore all descriptions related to use of a mobile device apply equally to non-mobile computing device. In some implementations, instead of accessing a dedicated application executing on the mobile device 102, the first user can use a browser of the mobile device 102 to access a website that provides the below described functionality and therefore all descriptions related to use of the dedicated application apply equally to a web-based implementation.

The first user logs into the dedicated application by entering a user name or other identifier and a password. Alternatively, the first user can log into the dedicated application by providing biometric information using one or more sensors of the mobile device 102 such as by scanning a fingerprint using a fingerprint scanner of the mobile device 102 or using a retina scanner of the mobile device 102 to scan the first user's retina information. In some implementations, the first user may be already logged into the dedicated application from a previous session.

The first user can use the dedicated application to select items for purchase from a store using an online shopping interface. For example, the dedicated application can be a grocery shopping application that can permit the first user to search and/or browse for grocery items, add desired items to a virtual shopping cart, and place an order for the selected items by entering payment information. The first user can also use the dedicated application to access one or more previously entered orders. For example, the first user may have previously logged into an online account for a retailer associated with the dedicated application and placed an on-line order for one or more items using either the mobile device 102 or a different computing device such as a home or laptop computer. As another example, the first user may have previously placed an on-line order using the dedicated application. The first user can access and review the previously placed orders after logging into the dedicated application. This can include reviewing items included in the orders and additional information associated with the orders such as an estimated time until the order is ready, payment used for the order (e.g., “card ending in 123”), a fulfillment location for the order, and other information associated with the orders.

The mobile device 102 can communicate with other computing devices through a network 116, such as, for example, the Internet. For example, the mobile device 102 can communicate with a network access point such as a WiFi router or a cellular communication tower to access the network 116 and communicate with other computing devices. For example, the mobile device 102 can communicate with a server system 118 consisting of one or more servers through the network 116 to place the order. Alternatively, or additionally, the first user can use a different computer to place the order and the different computer can communicate through the network 116 with the server system 118. The server system 118 can be affiliated with a retailer and process the on-line order received from the mobile device 102 or another computing device. The server system 118 can facilitate fulfillment of the order by providing details of the order, such as ordered items, identity of the first user, an order number, time that the order was placed, etc. to one or more computing devices located at a fulfillment center such as a store 120. For example, the store 120 can be part of a chain of affiliated stores associated with a retailer and the server system 118 can be a server system associated with the retailer. Upon receiving an on-line order from the first user, the server system 118 can identify the store 120 as an appropriate fulfillment location for the order based on information such as, an indication of a preferred location for fulfillment indicated by the first user at the mobile device 102 or another computing device, a current location of the mobile device 102, another location associated with the first user (e.g., home or work address information entered by the first user into a customer profile), a current location of a different mobile device, such as a mobile device 110 associated with a second user identified by the first user (described in detail below), based on item availability (e.g., by identifying a store where all or a majority of the items in the order are in stock), or based on a combination of these and one or more other factors.

In some instances, the server system 118 transmits information on the order to a computing device 122 in the possession of, or being used by, an employee of the store 120. The computing device 122 can be a mobile computing device, such as, for example, a mobile phone, a tablet device, a touch screen computer, a laptop computer, a PDA, a smart watch, or other mobile device. In some implementations, the computing device 122 can be a non-mobile or semi-mobile device such as a server, a desktop computer, a cash register, a smart TV, or other computing device. The server system 118 can provide appropriate information for the order to the computing device 122 such as items in the order, identifying information for the first user who placed the order, identifying information for an alternate pickup shopping partner, time the order was placed, a desired pickup time for the order (e.g., as indicated by the first user at the time of placing the order or as identified by a designated shopping partner for the order), an order number, and other relevant information.

At the time of placing the order, or at a different time, such as when logging into the dedicated application, when accessing a preferences menu, or when reviewing the order after placing the order, the first user of the mobile device 102 can identify one or more other people as alternate pickup persons (shopping partners) for the order. For example, at the time of completing an order, the mobile device 102 can present a user interface 104 that allows the first user to enter an identifier for an alternate pickup shopping partner to initiate a process to authorize the identified alternate pickup shopping partner to pick up the order. For example, the first user can create an order by selecting items for the order. The first user can then complete the order by designating an order fulfillment option (discussed in detail below), entering payment information or selecting a pre-stored payment method, and submitting the order. At the time of completion of the order (e.g., as part of the checkout process prior to submitting the order, or after the user has submitted the order), the mobile device 102 can present the user interface 104 to allow the first user to designate an alternate pickup person for the order.

For example, the user interface 104 can include a text box 106 that the first user can user to enter an identifier for a second user. The identifier can be, for example, a username for the second person that the second person uses to log into an instance of the dedicated application, an email address of the second user, a phone number of the second user, an ID number or code, or other identifying information that uniquely identifies the second user within an order processing system with which the dedicated application is associated. Upon entering the identifier for the second user in the text box 106, the first user can select a control 108 to submit the identifier for the second user to authorize the second user to pick up the order. In some implementations, the second user is only authorized to pick up the specific order that has just been placed by the first user. In some implementations, the first user can designate one or more orders placed by the first user that the second user is authorized to pick up (e.g., by selecting orders from a list of orders placed by the first user). In some implementations, the first user can specify that the second user is authorized to pick up all orders placed by the first user until the first user revokes such authorization. In some implementations, the first user can authorize the second user to pick up all orders placed by the first user during a specified time period (e.g., the next three days or the next two weeks).

In some implementations, the first user can authorize the second user to pick up orders for the first user from multiple different retailers. For example, the dedicated application can allow the first user to place different online orders for fulfillment by multiple different retailers. The first user can identify the second user as a shopping partner authorized to pick up orders placed by the first user for a sub-set of the retailers that accept orders through the dedicated application.

Upon the first user submitting the identifier for the second user to authorize the second user to pick up the order (e.g., by selecting the control 108), the mobile device 102 transmits a message through the network 116 to the mobile device 110 of the second user, inviting the second user to become a shopping partner for the designated order or orders. In some implementations, rather than a direct communication, the mobile device 102 transmits a communication to the mobile device 110 inviting the second user to become a shopping partner for the order or orders indirectly via the server system 118. For example, the mobile device 102 sends a communication to the server system 118 that includes the identifier for the second user entered by the first user via the user interface 104. The server system 118 can look up the second user using the identifier for the second user. Upon identifying the second user, the server system 118 can associate the second user with the order, e.g., by including the identifier for the second user (or a different identifier, such as a profile ID or username for the second user) in a field associated with the order in a database stored at or accessible by the server system 118.

The server system 118 can then transmit a communication to the mobile device 110 inviting the second user to accept the shopping partner invitation from the first user. The communication can take the form of, for example, an email, a text message (e.g., SMS or instant message), or a message in an instance of the dedicated application installed on the mobile device 110. For example, in some cases, the identifier for the second user entered by the first user using the user interface 104 may be an address or identifier that can be used to communicate with the second user, such as an email address, phone number, or messaging application screenname. In some implementations, the server system 118 can store or access communication information for the second user using the identifier for the second user and transmit the communication to the user using a retrieved communication address (e.g., phone number, email address, messaging application screenname, application username) for the second user. For example, the server system 118 can use the identifier for the second user to retrieve a profile for the second user. The profile can be, for example, a profile for a particular retailer associated with the dedicated application installed on the mobile device 110. The profile can include a username or other identifying information associated with the second user and the server system 118 can use this information to transmit a communication to the mobile device 110 that can be accessed by the dedicated application executing on the mobile device 110 to convey the invitation to be a shopping partner with the first user to the second user. In some implementations, the server system 118 does not actively transmit a communication to the mobile device 110 but rather passively provides the communication to the mobile device 110 by allowing the user to log in to an account on the server system 118 using the mobile device 110 (e.g., via an instance of the dedicated application executing on the mobile device 110) to access and confirm the invitation to become a shopping partner for the order placed by the first user

Upon receiving the communication indicating that the second user has been authorized to pick up one or more orders placed by the first user, the mobile device 110 can display a user interface 112 informing the second user that they have been authorized to pick up one or more orders for the first user. For example, the mobile device 110 can provide a push notification to the second user indicating that the second user has been authorized to pick up an order placed by the first user. The second user can then select the push notification and/or unlock the mobile device 110 to cause the mobile device 110 to display the user interface 112. For example, an instance of the dedicated application executing on the mobile device 110 can cause a push notification to be displayed on a lock screen for the mobile device 110 indicating that the second user has been invited to be a shopping partner for the first user. The second user can select the push notification which can cause the mobile device 110 to open the dedicated application and dedicated application can display the user interface 112.

As another example, the invitation to become a shopping partner with the first user can be transmitted to the mobile device 110 via text message or email. In some instances, receipt of the text message or email will cause the mobile device 110 to display a notification of the received communication. The notification may include a portion or all of the text of the communication and/or may include additional information about the communication, such as by identifying the dedicated application, the retailer, or the first user. The second user can access the received text message or email using a text messaging application, email application, web browser, or other application installed on the mobile device 110. The received text message or email may include a link that, when selected by the second user using a user interface of the mobile device 110, links to invitation to become a shopping partner of the first user with respect to one or more orders. For example, the second user can select a link displayed in a received text message to cause the mobile device 110 to display the user interface 112 in a web browser or in the dedicated application.

In some implementations, the user interface 112 displays relevant information about the order. For example, the example shown in FIG. 1, the user interface 112 indicates that Ted H. (i.e., the first user) has authorized the second user to pick up the order having order identifier 3cq-196. If the second user does not know Ted H. (e.g., the first user erroneously identified the second user when intending to identify a different person (such as by entering an incorrect phone number)) the second user can decline the invitation to pick up the order. In the example in FIG. 1, the user interface 112 also identifies the location where the order can be picked up, including the address for the fulfillment location. In some implementations, the second user can select the displayed address to cause the dedicated application, a mapping application, or a browser installed on the mobile device 110 to display the fulfillment location on a map and/or driving directions to the fulfillment location. Other information that can be provided by the user interface 112 can include an estimated time that the order will be ready for pick up, information on the items in the order (or the number of items in the order), or pick up instructions (e.g., “pick up order entrance in rear of store”).

The user interface 112 includes a control 114 that, when selected, allows the second user to accept the invitation to pick up the order placed by the first user and/or view additional details about the order. These additional details can include fulfillment location, estimated pick up time, items in the order, number of items in the order, pick up instructions, an order identifier, and/or a verification code, such as an optically recognizable code (e.g., a barcode or a matrix barcode), that can be used to verify that the second user is authorized to pick up the order. In some implementations, the second user does not need to accept the invitation to pick up the order, the second user is authorized to pick up the order in response to the first user submitting the identifier for the second user as an alternate pick up person using the user interface 104. In some instances, the second user is not permitted to pick up the order until accepting the shopping partner invitation. For example, the second user is not permitted to pick up the first order until the second user selects the control 114 or an acceptance control on an order details page displayed in response to selection of the control 114.

In some implementations, upon the second user accepting the invitation to pick up the order, the mobile device 110 sends a communication to the server system 118 indicating that the second user has accepted the invitation. In some implementations, this can cause the server system 118 to transmit one or more additional communications to the mobile device 110 that include additional information associated with the order. Such information can include fulfillment location, estimated pick up time, items in the order, number of items in the order, pick up instructions, or verification code, such as an optically recognizable code (e.g., a barcode or a matrix barcode), that can be used to verify that the second user is authorized to pick up the order. For example, an employee of the retailer at the fulfillment location can use a computing device to scan the optically recognizable code to verify that the second user is authorized to pick up the order.

In some implementations, the user interface 112 (or another user interface linked to by the user interface 112) allows the second user to enter relevant information related to the order and the process of picking up the order. For example, the second user can enter identifying information for her vehicle, such as make, model, vehicle type (e.g., sedan, mini-van, pickup truck, etc.), color, or license plate number. Such information can be used by an employee of the retailer to identify the second user's vehicle in instances in which the second user is using drive-up fulfillment for the order (sometimes referred to as “curb-side pickup”). In some instances, such identifying information for the second user's vehicle is pre-stored. For example, the second user can have a profile for the retailer or a profile for the dedicated application and the server system 118 can store relevant identifying information for the second user's vehicle in association with the second user's profile. In some implementations, the second user can pre-store identifying information for multiple vehicles and select which vehicle they are driving when picking up the order on that day. In some implementations, the user interface 112 allows the second user to specify where in the vehicle items for the order should be placed, such as in the trunk, rear passenger side door, side sliding van door, back of a truck, etc.

In some implementations, the first user or the second user can select a fulfillment type for the order. For example, the second user can specify that the order is for drive-up fulfillment. A drive-up fulfillment allows the second user to drive to a fulfillment location, such as a retail store location, a warehouse, or another location where an employee of the retailer can meet the second user at the second user's vehicle, verify that the second user is receiving the proper order (i.e., the order placed by the first user), and provide the items to the second user without the second user being required to exit her vehicle. For example, the second user can travel to the store 120, park in a designated area of the parking lot of the store 120, notify an employee that they have arrived (e.g., using the user interface 112), and then receive the purchased items for the order from the employee when the employee brings the items to the second user's.

As another example, the second user can specify in-store pickup fulfillment for the order. In-store pickup fulfillment can allow the second user to travel to a fulfillment location, such as the store 120, and enter the store to pick up the purchased items from a designated location within the fulfillment location. Such a fulfillment method can allow the second user greater flexibility by allowing the second user to shop for additional items within the store 120 (e.g., items that the second user wishes to see in-person before purchasing, such as clothing or produce). In-store pickup fulfillment allows the second user to purchase items in addition to the items included in the order placed by (and paid for) by the first user. After completing her own shopping in the store, the second user can pick up the items from the on-line order placed by the first user at the designated location. Alternatively, the second user can pick up the order items without also shopping for additional items at the store 120 in person.

In some instances, the first user can specify a fulfillment type for the order (e.g., drive-up fulfillment, in-store pick up, delivery) and the second user, once authorized as a shopping partner for the order, can change the fulfillment type for the order. For example, the first user may select drive-up fulfillment for the order. The second user can then change the fulfillment type for the order to in-store pick up because the second user wishes to purchase additional items at the store.

In some implementations, the first or second user can specify a desired fulfilment time for the order. For example, the first user can specify a desired pickup time of 1:00 pm for the order at the time of placing the order using the mobile device 102. The second user can change the specified pickup time designated by the first user using the mobile device 110. For example, the second user can change the pickup time to 3:30 pm. In some instances, the second user is only allowed to change the designated pickup time outside of a specified time window (e.g., the second user cannot change the designated pickup time within 30 minutes of the initially specified pickup time). In some instances, the first user does not specify a pickup time and the desired pickup time is specified by the second user, such as at the time of accepting the invitation to become a designated shopping partner.

In some cases, when the second user has indicated drive-up or in-store pickup type order fulfillment, the dedicated application can provide navigation directions, such as driving directions, to the fulfillment location (e.g., store 120). For example, the dedicated application can communicate with a native routing application installed on the mobile device 110 or with one or more remote routing servers to identify a route from either the second user's current location or a specified starting location to the store 120. As another example, the mobile device 110 can communicate with the server system 118 through the network 116 to receive routing information from either the second user's current location or the specified starting location to the store 120. The dedicated application can, for example, then provide a map display showing a route to the store 120. As another example, the dedicated application can provide turn by turn directions to the store 120 using text and/or icons in addition to or in place of the map display.

In some implementations, the second user can permit the dedicated application to access location information for the mobile device 110. For example, the second user can set a permissions setting permitting the dedicated application to access location information for the mobile device 110. In some implementations, the second user can specify that the dedicated application is only permitted to access location information for the mobile device 110 when the dedicated application is executing or can specify that the dedicated application is always permitted to access location information for the mobile device 110 even when a user interface for the dedicated application is not open. The mobile device 110 can determine its own location using one or more well-known techniques, such as by using a GPS module for receiving GPS signals from GPS satellites to determine the location of the mobile device 110. The mobile device 110 can also use a wireless communication triangulation technique to determine the location of the mobile device 110. As another example, the mobile device 110 can determine its location based on the location of a network access point that the mobile device 110 is in short range wireless communication with (e.g., a WiFi router). The dedicated application can use the location information to identify a starting location for the route to the store 120, such as the current location of the mobile device 110.

In some implementations, the second user can specify when they are on their way to pick up the order by selecting a control provided by the dedicated application executing on the user interface 112. The mobile device 110 can then send a communication to the server system 118 indicating that the second user has begun to travel to the fulfillment location (e.g., the store 120) and can relay this information to the employee, such as providing a communication to the computing device 122 that can cause the computing device 122 to display a notification that the second user is on her way to pick up the order. In some implementations, the dedicated application executing on the computing device 122 (or the server system 118) can determine that the second user has begun to travel toward the fulfillment location based on GPS information or other location information for the mobile device 110 without receiving express input from the second user. The mobile device 110 can communicate with the server system 118 over the network 116 to indicate to the server system 118 that the second user has begun to travel toward the store 120.

The server system 118 can then provide a communication to the computing device 122 of the store employee to indicate that the user of the mobile device 110 is on the way. The server system 118 may communicate directly with the computing device 122 through the network 116 or may communicate with a computing device/system located at the store 120 which then communicates with the computing device 122, e.g., through a wireless or wired local area network (LAN). In some implementations, the server system 118 or a central computing device located at the store 120 can communicate with the computing device 122 and one or more other computing devices in possession of other employees of the store 120 to allow multiple employees to receive information on on-line orders placed by customers and coordinate efforts to fulfill such orders.

The server system 118 can provide additional information along with this notification or prior to sending the notification that the user is on the way. For example, the server system 118 can retrieve information previously provided by the second user, such as by accessing user profile information for the second user, to identify a make and model for the second user's vehicle, a color for the second user's vehicle, and/or other identifying information for the second user's vehicle (such as a whole or partial license plate number) and provide this vehicle identification information to the computing device 122 to allow the employee to more easily identify the second user's vehicle when the second user has arrived at a designated drive-up fulfillment location at the store 120. The server system 118 can store this vehicle identification information as part of a customer profile for the second user or the second user can provide the information at the time of accepting the invitation to be a shopping partner for the on-line order placed by the first user.

The server system 118 can also provide information on an estimated time of arrival and/or an estimated time until arrival for the user. For example, the mobile device 110 can calculate an estimated time until arrival for the second user based on the estimated time for traversing the route to the store 120 and provide this information to the server system 118 which can then provide the estimated time until arrival information to the computing device 122. As another example, the server system 118 can receive location information from the mobile device 110 (after the second user has granted permission to provide such information) and use this location information to calculate an estimated time until arrival for the second user. For example, the second user can give the dedicated application permission to access location information for the mobile device 110. A GPS unit or other location detection unit of the mobile device 110 can regularly determine the location for the mobile device 110. At the time of indicating to the server system 118 that the second user has begun to travel to the store 120, the mobile device 110 can also indicate the current location of the mobile device 110. The server system 118 can then use either an internal time estimation routine, or communicate with an external routing system to identify an estimated time required for the user to travel from the current location of the mobile device 110 to the store 120 using any one of many known techniques. The server system 118 can then provide this estimated time until arrival information to the computing device 122, which can then provide this information to the employee. Such estimated time of arrival can be updated by the server system 118 and/or the mobile device 110 on a regular basis. The server system 118 can then provide this updated estimated time of arrival to the computing device 122 for display to the employee. For example, the second user may be delayed by traffic or may stop to get gas, which can cause the estimated time of arrival to be delayed from the original estimate.

The computing device 122 includes a user interface 124. The user interface 120 can, for example, be a user interface for another dedicated application executing on the computing device 122 or another instance of the same dedicated application that is executing on the mobile devices 102 and 110. The user interface 124 includes a user selectable control 126 that allows the employee to view all arriving orders (e.g., orders for which a customer is on the way). The employee can select the control 126 by, for example, using a touch screen interface of the computing device 122 or one or more other input devices of or in communication with the computing device 122. The user interface 120 further includes a control 128 to allow the employee to view all placed orders. This could include all orders placed for fulfillment at the store 120 or all orders assigned specifically to the employee for fulfillment. Selection of the all orders control 128 can cause the user interface 124 to display all orders that have been placed for fulfillment regardless of the user's status (e.g., orders for users that are on the way and orders for users that are not yet on the way).

In the example depicted in FIG. 1, the control 126 is selected and the user interface 120 is displaying a list 130 of orders for which a customer is currently on the way and/or has already arrived at the store 120. The order list 130 includes an individual listing for each arriving order. For example, an order listing 132 in the list 130 includes a name for the first user who placed the order (“Ted H.”, user of the mobile device 102) and further indicates a designated pickup person for the order, in this case the second user associated with the mobile device 110 (“Cindy L.”). This listing thus indicates that Ted H. placed the order and that Cindy L. has been designated to pick up the order. In some instances, the listing 132 does not include identifying information for the person who placed the order and/or the person designated as the pick up person for the order. For example, the listing 132 may include only the order owner (“Ted H.”) only the designated pick up person (“Cindy L.”) or may include neither name and only include an order identifier. The order listing 132 further indicates an estimated time until the designated pickup person (the second user) is predicted to arrive at the store 120 (23 minutes) and an icon 134 indicating that the designated pickup person associated with the order listing 132 has selected drive-up order fulfillment.

The user interface 124 further includes an order listing 136 indicating that a customer named “Brent F.” is estimated to arrive at the store 120 in 26 minutes and includes an icon 138 indicating that Brent F. has selected in-store pickup order fulfillment. The order listing 136 does not include an indication of a designated pickup person and therefore, in this example, indicates that Brent F. has not designated a shopping partner to pick up the order that he placed but rather is picking up the order himself. In some implementations, in place of or in addition to the indication of an estimated time until arrival, each order listing can include a time indicator indicating the predicated time of arrival for the customer (e.g., 3:15pm). In some implementations, the order listings in the list 130 can include less or more details with respect to each order. For example, each order listing can include an order number. As another example, each order listing can include vehicle identification information.

In some implementations, order listings in the list 130 are user selectable to allow the employee to view additional information about each order. For example, the employee can select the order listing 132 to cause the user interface 120 to display additional information about the order placed by Ted H. (which in this example is the user of mobile device 102). Additional details that can be displayed by the user interface 120 in response to selection of the order listing 128 can include identifying information for the second user designated as a order pickup shopping partner (“Cindy L.”), identifying information for the second user's vehicle, an order number, a listing of items in the order, special instructions or requests entered by the first or second user, location information for bags containing the items for the order (e.g., one or more shelf or bin locations at a drive-up order fulfillment staging area), a number of bags for the order, an indication as to whether or not the order includes age restricted items (e.g., cold medicine, alcohol, etc.), and other information for the order.

When the second user arrives at the store 120 to pick up the order (either by parking in a designated drive-up fulfillment parking spot or by entering the store 120 and proceeding to a designated in-store pickup desk or area), the dedicated application executing on the mobile device 110 can display an optically readable code that can be scanned by the employee (e.g., using an optical scanner of the computing device 122) to verify that the second user is authorized to pick up the order. For example, the dedicated application can, upon determining that the second user has arrived at or near the store 120 (e.g., based on GPS signals received by the mobile device 110), display a bar code that can be scanned by the computing device 122 to verify that the second user is authorized to pick up the order. As another example, the second user can interact with the instance of the dedicated application executing on the mobile device 110 to cause the dedicated application to display a scanable bar code for verifying the second user on the 1 0 display screen of the mobile device 110.

Upon scanning the optically readable code displayed by the mobile device 110, the computing device 122 can access information associated with the scanned code. For example, the optically readable code can include information indicative of the second user, such as a unique user ID for the second user. The computing device 122 can provide the user ID received by scanning the optically readable code to the server system 118. The server system 118 can then provide a verification message to the computing device 122 to present to the employee to indicate that the second user has been verified and is authorized to pick up the order placed by the first user.

In some implementations, the server system 118 can use the unique user ID for the second user to look up all orders associated with the second user and provide information on such orders to the computing device 122. For example, in addition to the first user designating the second user as a shopping partner authorized to pick up the order placed by the first user, the second user may also be authorized to pick up an order placed by a third user, and the second user may have also placed an order herself. The server system 118 can use the unique user ID for the second user (communicated to the computing device 122 by the optically readable code) to identify that the second user is associated with and authorized to pick up all three orders (i.e., the orders placed by the first, second, and third users, respectively). For example, the unique user ID for the second user can be associated with an entry for each order in a database stored by or accessible by the server system 118. The server system 118 can return identifying information for each order that the second user is authorized to pick up to the computing device 122, such as an order ID for each order.

The computing device 122, upon receiving the order IDs for the orders that the second user is authorized to pick up, can display information for each order (e.g., order ID, location of each order in a staging area, or other identifying information) to allow the employee to provide the items for each order to the second user. In some instances, the computing device 122 can display the second user's name and the employee can check an ID card (e.g., driver's license) for the second user to verify the second user's identity and confirm that it matches with the user ID provided by the optically readable code. Upon verifying the second user's identity, the employee provides the items for each order to the second user.

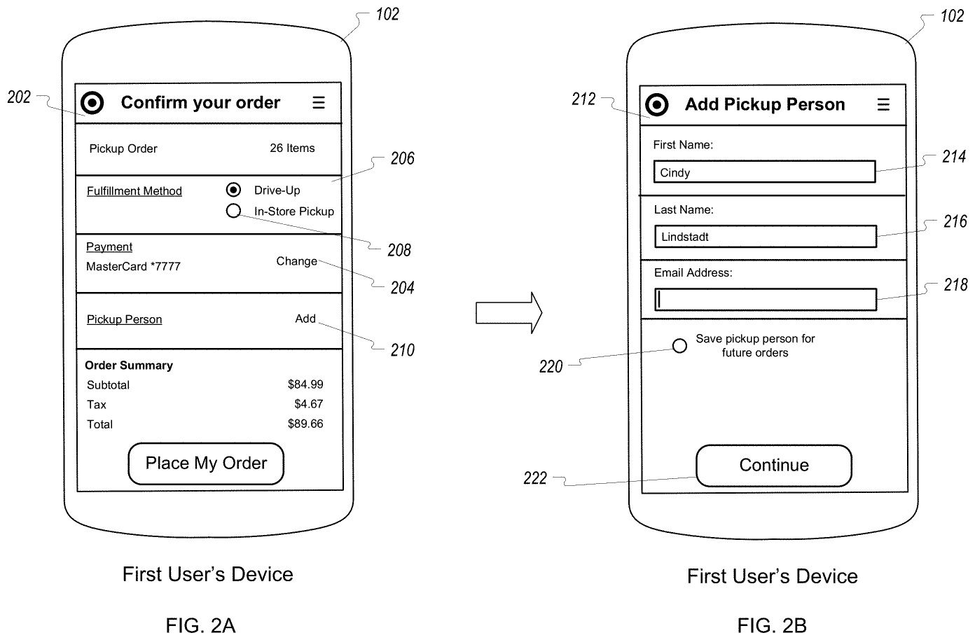

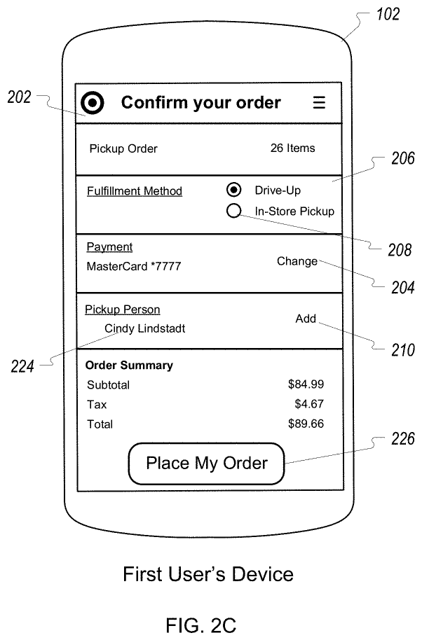

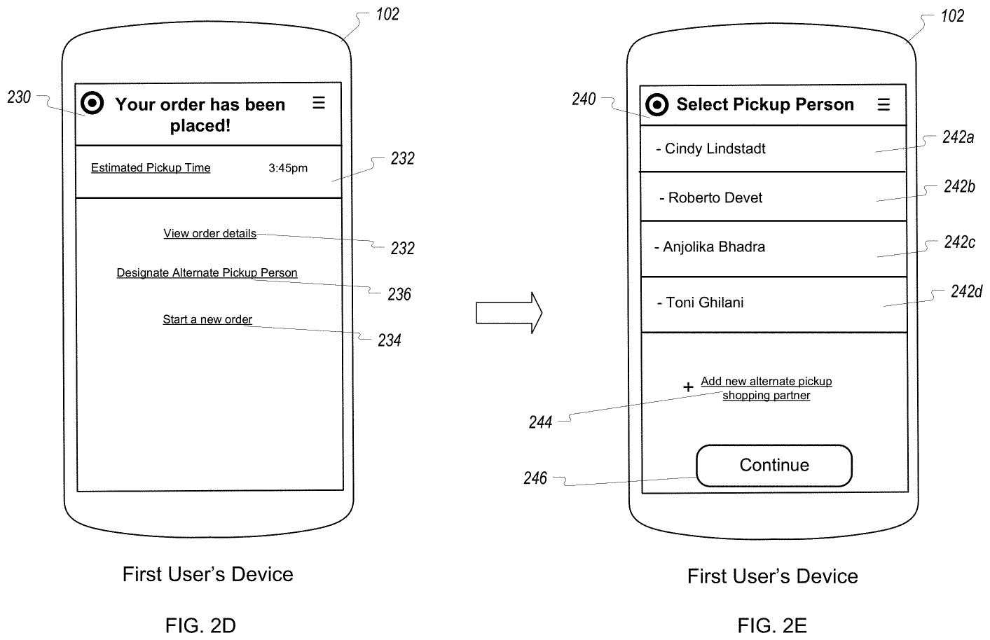

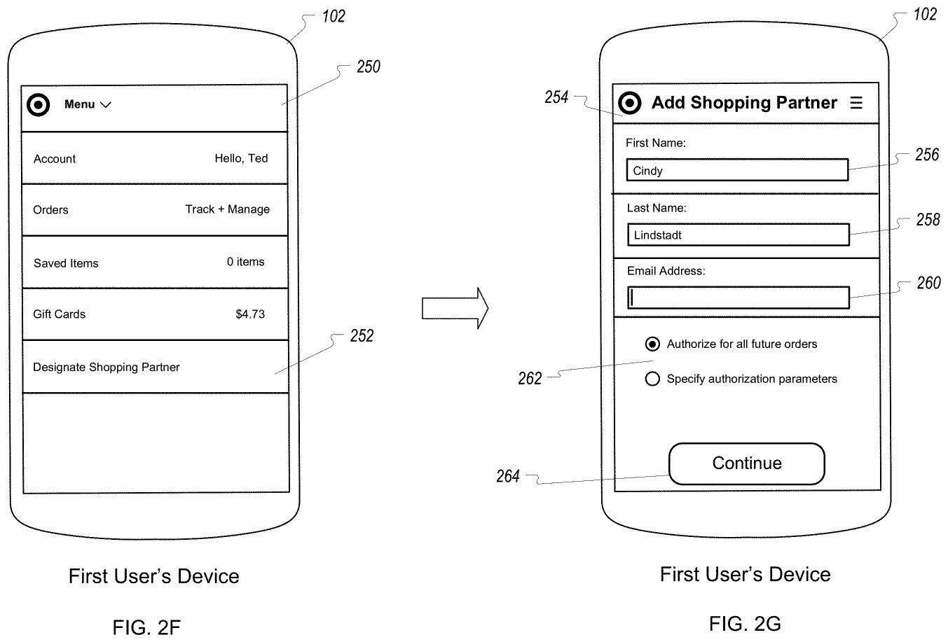

There are multiple methods by which the first user, associated with the mobile device 102, can designate the second user, associated with the second mobile device 110, as a shopping partner authorized to pick up one or more orders placed by the first user. FIG. 2A shows a user interface 202 of the mobile device 102 that the first user can use to designate other people as shopping partners to authorize them to pick up orders placed by the first user. Specifically, the user interface 202 is a user interface displayed by the dedicated application as part of a checkout process for placing an order for pickup. The user interface 202 provides information about the order, including identifying that the order is a pickup order, identifying the number of items in the order (“26 items”), a subtotal, tax amount, and total cost for the transaction, and a payment method for the order. The payment method can be, for example, a pre-stored payment method and the user can change the payment method by, for example, selecting a control 204 to change the payment method.

The user interface 202 further optionally includes a control 206 that allows the user to designate an order fulfillment type for the order. In the example shown in FIG. 2A, the control 206 indicates that the first user has selected drive-up order fulfillment and further includes an option to change the order fulfillment type to in-store pickup. The user can interact with the control 217 to change the order fulfillment type to in-store pickup, e.g., by selecting a selection area 208 next to an indication for “In-Store Pickup.” In some implementations, the fulfillment method can include additional options, such as an option for delivery of the order.

The user interface 202 further includes a control 210 that allows the first user to designate one or more pickup persons for the order. For example, selection of the control 210 can cause the mobile device 102 to display a user interface 212, displayed in FIG. 2B. The user interface 212 allows the first user to enter information for a designated pickup person to authorize the designated pickup person to pick up the order that the first user is currently placing. The user interface 212 includes a field 214 for entering a first name of the designated pickup person, a field 216 for entering a last name of the designated pickup person, and a field 218 for entering an email address for the designated pickup person. The email address can be, for example, an email address that the designated alternate pickup person has used to register for an account with the retailer associated with the dedicated application. In some implementations, the user interface 212 elicits more, less, or different information about the designated alternate pickup person. For example, the user interface 212 can only elicit an email address or other communication identifier for the designated alternate pickup person (e.g. a phone number) and does not require that the first user enter a name for the designated alternate pickup person. However, entering both a name and a method of contacting the designated alternate pickup person can help ensure that the correct person is designated as the alternate pickup person (e.g., in instances where the first user mistypes the email address of the alternate pickup person). In some implementations, the user interface 212 elicits different contact information for the designated alternate pickup person, in place of or in addition to the email address, such as a phone number, messaging app username, a username associated with the designated alternate pickup person's account with the retailer, or another unique identifier for the designated alternate pickup person.

The user interface 212 includes a control 220 that allows the first user to save the alternate pickup person identified using the fields 214, 216, 218 to use for future orders. For example, the control 220 can cause the server system 118 to save the entered alternate pickup person in association with a profile for the first user. When placing future orders, when the first user designates an alternate pickup person (e.g., by selecting the control 210), the dedicated application can present a list of previously saved alternate pickup persons to allow the first user to select a previously designated alternate pickup person for an alternate pickup person for a new order. In some implementations, the user interface 212 can include an option to allow the first user to indicate that the alternate pickup person identified using the fields 214, 216, 218 is authorized to pick up all orders placed by the first user. The designated alternate pickup person can then pick up not only the order currently be placed by the first user but also future orders placed by the first user and previous placed but yet to be fulfilled orders placed by the first user. The first user can revoke such authorization at any time using, for example, a settings menu of the dedicated application. Upon completing the form displayed in the user interface 212, the first user selects the control 222 to submit the entered information for the alternate pickup person identified using the fields 214, 216, 218.

Selection of the control 222 can cause the mobile device 110 to display an updated version of the user interface 202, as shown in FIG. 2C. In this updated user interface 202, the entered alternate pickup person 224 is now identified by the user interface 202. The first user can select the control 210 to enter additional alternate pickup persons for this order. Upon reviewing the order for accuracy, the first user can select a control 226 to submit the order.

FIG. 2D shows a user interface 230 of the dedicated application executing on the mobile device 102 that can be used to identify an alternate pickup person after the first user has placed the order. The user interface 230 includes an indication of the estimated pickup time for the order 232. In some implementations, the user interface 232 can allow the first user to change the designated pickup time for the order. The user interface 212 includes a control 232 that allows the first user to view details of the order placed by the first user. The user interface further includes a control 234 that allows the first user to start a new order, e.g., a new delivery order after submitting the pickup order. The user interface also includes a control 236 that allows the first user to designate an alternate pickup person for the order. For example, the checkout sequence may not have included an option for designating an alternate pickup person for the order (such as the control 210 shown in FIG. 2A). Selection of the control 236 can cause the dedicated application executing on the mobile device 102 to display a user interface for adding an alternate pickup person, such as the user interface 212 shown in FIG. 2B. Alternatively, selection of the control 236 of FIG. 2D (or the control 210 of FIG. 2A) can cause the dedicated application executing on the mobile device 102 to display an alternate version of the user interface for designating an alternate pickup person.

For example, selection of the control 236 of the user interface 230 can cause the dedicated application to display the user interface 240 shown in FIG. 2E by which the first user can select one or more alternate pickup persons for the order. For example, the user interface 240 includes controls 242a-d that can be selected by the first user to select previously identified shopping partners as authorized alternate pickup persons for the current order. For example, the first user may have previously identified each of the alternate pickup persons shown on the user interface 240 using the user interface 212 of FIG. 2B in association with previously placed and fulfilled orders. The first user may have selected the control 220 to save the information for each of these previously designated alternate pickup persons. The controls 242a-d allow the first user to identify one or more of these previous alternate pickup persons as alternate pickup persons authorized to pick up the current order. In some implementations, the first user may select more than one of the controls 242a-d to designate multiple alternate pickup persons for the current order such that each designated alternate pickup person is authorized to pick up the current order.

The user interface further includes a control 244 that the first user can select to add a new alternate pickup person not listed on the user interface 240. Selection of the control 244 can, for example, cause the mobile device 102 to display the user interface 212 of FIG. 2B to allow the first user to enter information for a new alternate pickup person for the current order. Returning to FIG. 2E, after selecting and/or adding one or more alternate pickup persons for the current order, the first user can select a control 246 to submit the selection which can cause the mobile device 102 to transmit one or more communications to initiate a process by which the identified alternate pickup persons are authorized to pick up the current order.

In some implementations the first user can designate one or more shopping partners to authorize to pick up the order after the time of placing and/or confirming the order. For example, the first user may initially intend to pick up the order himself but may become busy between placing the order and the designated pick up time. The first user can then designate one or more alternate pick up persons for the order, such as by logging into the dedicated application, viewing the order details, and selecting a control to designate an alternate pickup person for the order, which can, for example, cause the user interface 240 of FIG. 2E or the user interface 212 of FIG. 2B to be displayed. As another example, the first user can log into an account for the retailer associated with the dedicated application (e.g., using a web browser on the mobile device 102, a web browser on another computing device, or a dedicated application on another computing device) and review the order details. The first user can select a control to add an alternate pickup person for the order on the order details screen. In some implementations, the first user can add an alternate pick up person for an order at any time up until the order is picked up. In some implementations, when identifying an alternate pick up person, the first user can identify multiple orders that the alternate pick up person is authorized to pick up.

Turning to FIG. 2F, as previously mentioned, in some implementations, rather than (or in addition to) allowing users to specify designated shopping partners at the time of placing an order or after placing an order but prior to fulfillment, users can specify authorized alternate pick up persons (shopping partners) prior to placing an order. For example, with respect to FIG. 2F, the first user can use a user interface 250 of the designated application to identify one or more people as alternate pickup persons authorized to pick up future orders for the retailer placed by the first user. For example, the user interface can be a main menu or a settings menu for the dedicated application. In the example shown, the user interface 250 includes controls that the first user can select to view details on his account, start a new order or view details on placed orders, view saved items (e.g., for later purchase or review), and view giftcard balances. In some implementations, the user interface 250 can include other controls that allow for other functionality, such as allowing the first user to manage payment methods (e.g., by adding or removing credit card information).

The user interface 250 shown in the example in FIG. 2F also includes a control 252 that allows the first user to designate one or more shopping partners. Selection of the control 252 can cause the dedicated application to display a user interface 254 as shown in FIG. 2G. The user interface 254 includes a field 256 for entering a first name of a alternate pickup person, a field 258 for entering a last name of the alternate pickup person, and a field 260 for entering an email address for the alternate pickup person. The email address can be, for example, an email address that the designated alternate pickup person has used to register for an account with the retailer associated with the dedicated application. In some implementations, the user interface 254 elicits more, less, or different information about the designated alternate pickup person. For example, the user interface 254 can only elicit an email address or other communication identifier for the designated alternate pickup person (e.g. a phone number) and does not require that the first user enter a name for the designated alternate pickup person. However, entering both a name and a method of contacting the designated alternate pickup person can help ensure that the correct person is designated as the alternate pickup person (e.g., in instances where the first user mistypes the email address of the alternate pickup person). In some implementations, the user interface 254 elicits different contact information for the designated alternate pickup person, in place of or in addition to the email address, such as a phone number, messaging app username, a username associated with the designated alternate pickup person's account with the retailer, or another unique identifier for the designated alternate pickup person.

The user interface 254 includes a control 262 that allows the first user to authorize the specified alternate pickup person identified using the fields 256, 258, 260 to pick up all future orders (the option selected in the example of FIG. 2G) or to specify authorization parameters. The first user can revoke such authorization at any time using, for example, a settings menu of the dedicated application. Examples of a authorization parameters include allowing the first user to specify specific orders that the identified alternate pickup person is authorized to pick up, allowing the first user to specify a time frame during which the identified alternate pickup person is authorized to pick up orders for the first user (e.g., the next two weeks, or specified dates), allowing the first user to specify specific locations at which the identified alternate pickup person is authorized to pick up orders placed by the first user, or other restrictions related to picking up orders for the first user. Upon completing the form displayed in the user interface 254, the first user selects a control 264 to submit the entered information for the alternate pickup person identified using the fields 256, 258, 260.

Upon identifying one or more alternate pickup persons and submitting the information for the alternate pickup persons, such as by using one of the user interfaces discussed with respect to FIGS. 2A-2G, the mobile device 102 transmits a communication to a server, such as the server system 118 of FIG. 1, including the entered information for the alternate pickup person and an indication of one or more orders for which the alternate pickup person is authorized, information indicating that the alternate pickup person is authorized to pick up all orders placed by the first user, or information indicating that the alternate pickup person is authorized to pick up placed by the first user within specific parameters designated by the first user.

The server system 118 can use the provided information to search a user profile database to determine if the identified alternate pickup person has an account associated with the retailer (e.g., such as by searching by an email address provided by the first user or a user identifier provided by the first user). If the identified alternate pickup person has an account with the retailer, the server system 118 can associate an identifier for associated with the identified alternate pickup person or the account for the identified alternate pickup person with one or more orders specified by the first user for which the identified alternate pickup person is authorized to pick up the orders. For example, the server system 118 can look up specified orders according to order IDs for the orders and associated an identifier for the identified alternate pickup person with each specified order within an order database. For example, a record for a specified order can include a field for the order number, a field for an owner ID (i.e., an identifier associated with the user that placed the order), and one or more fields for storing identifiers for shopping partners identified by the user who placed the order as being authorized to pick up the order. In some implementations, any user having an order ID associated with the order in the record for the order (including both the order owner and identified alternate pickup persons) is permitted to pick up the order.

In examples in which the first user identifies an alternate pickup person to be authorized to pick up all orders placed by the first user (or all orders within certain parameters), the server system 118 can associate the user profile for the identified alternate pickup person with the user profile for the first user. For example, a shopping partner field in the profile for the first user can be populated with an identifier associated with the profile for the identified alternate pickup person to identify that the identified alternate pickup person is an authorized shopping partner for the first user.

The server system 118 contacts the identified alternate pickup person, such as by using contact information for the identified alternate pickup person provided by the first user or contact information stored in a user profile for the identified alternate pickup person, to inform the identified alternate pickup person that the first user has identified them as an alternate pickup person for one or more orders. In some implementations, the profile for the identified alternate pickup person is not associated with the specified orders or with the first user's profile until the identified alternate pickup person has confirmed the request to be a shopping partner, such as be selecting a control displayed by an instance of the dedicated application executing on the mobile device 110. In some implementations, the identified alternate pickup person can decline the invitation to become a shopping partner of the first user. In such circumstances, the server system 118 does not associate the identified alternate pickup person's profile with the specified order and/or the first user's profile.

In some circumstances, the identified alternate pickup person may not have an account with the retailer at the time that the first user identifies the identified alternate pickup person as an alternate pickup person. Or the identified alternate pickup person may have an account with the retailer but the account may be associated with a different contact method than that provided by the first user. For example, the identified alternate pickup person may have multiple email accounts. The first user may have provided a first email address for the identified alternate pickup person but the profile for the identified alternate pickup person is registered under a second, different email address. In such instances where the identified alternate pickup person is not registered with retailer or has registered using different information, the server system 118 is unable to find a profile for the identified alternate pickup person.

If the server system 118 is unable to identify a user profile for the identified alternate pickup person, the server system 118 can use the contact information for the identified alternate pickup person provided by the first user (e.g., the email address provided via the user interface 212 of FIG. 2B) to contact the identified alternate pickup person and invite the identified alternate pickup person to register with the retailer to permit the identified alternate pickup person to pick up the order. In some implementations, the identified alternate pickup person will provide information to register with the retailer and create a full user profile for the retailer. In some implementations, the identified alternate pickup person is not required to fully register with the retailer and rather can merely register as a shopping partner with the retailer, thus allowing the identified alternate pickup person to pick up one or more orders for the first user without having to fully register with the retailer. Upon registering/creating a profile in response to the invitation provided by the server system 118, an identifier for the profile of the identified alternate pickup person is associated with the specified orders and/or the profile for the first user in the manner described above.

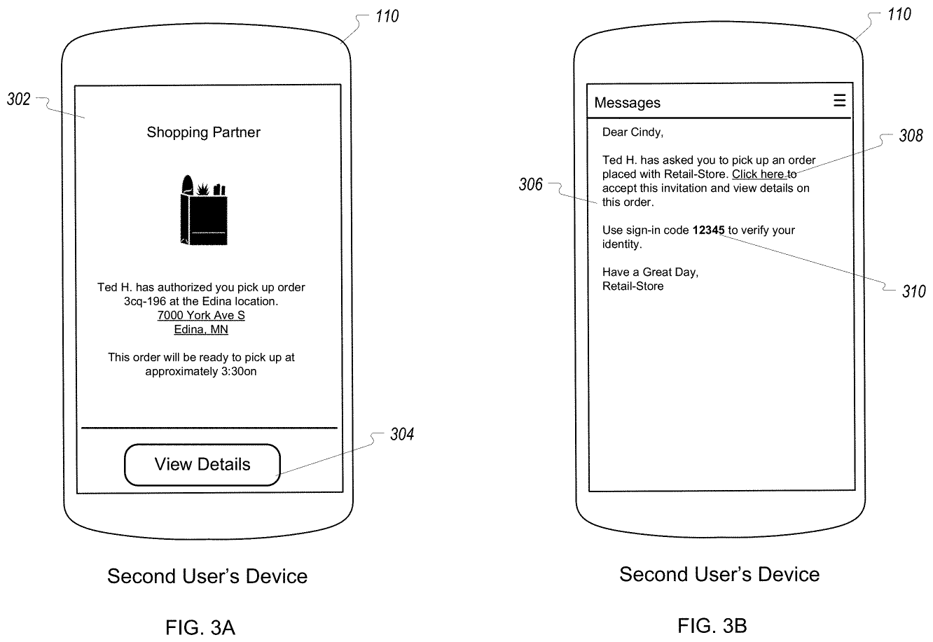

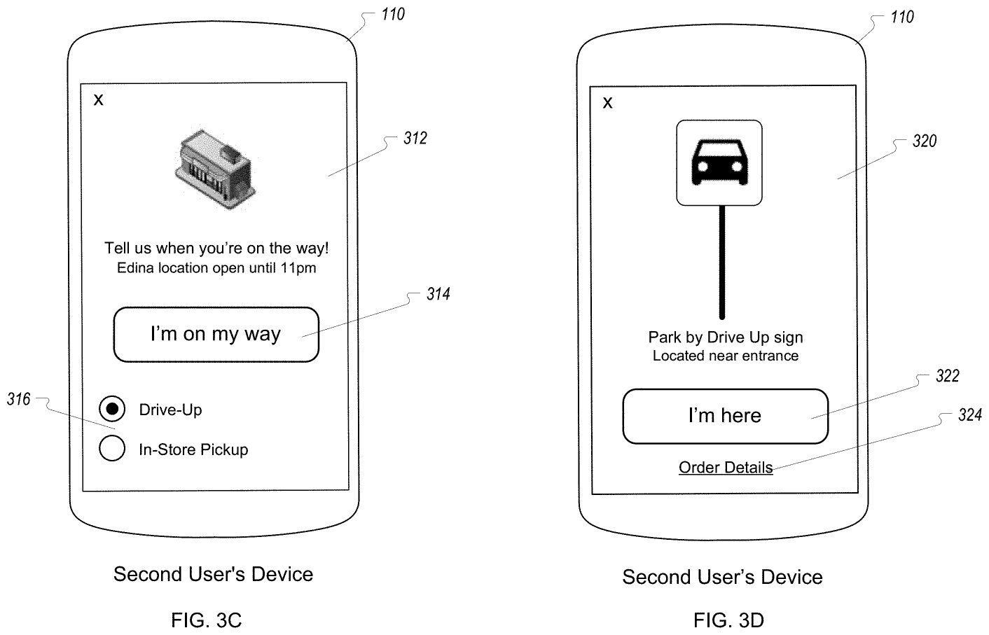

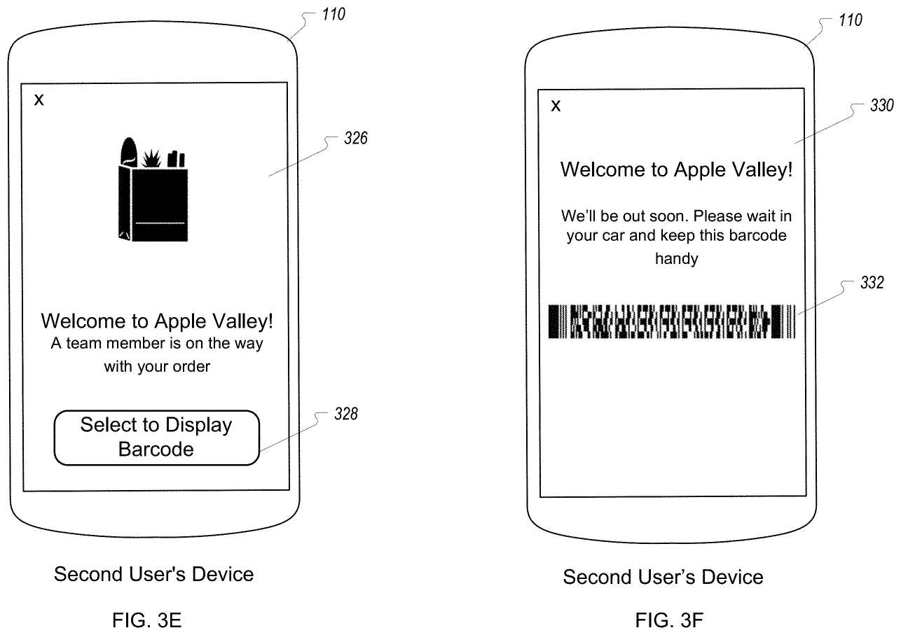

Turning to FIG. 3A, in response to receiving a communication from the server system 118 indicating that the first user has identified the second user (i.e., the user of the mobile device 110) as an alternate pickup person, the mobile device 110 can display a notification indicating such to the second user. For example, the server system 118 can provide information to the mobile device 110 to be displayed by an instance of the dedicated application executing on the mobile device 110. The dedicated application can use the information received from the server system 118 to provide a user interface 302 indicating that the first user has identified the second user as a shopping partner for an order. In this example, the user interface 302 includes information about the order, including the order owner (the identity of the first user that placed the order), the location where the order can be picked up, and an estimated time of when the order will be available for pick up. In some implementations, the upon receiving the communication from the server system 118, the dedicated application can cause the mobile device 110 to provide a push notification to the second user indicating that the second user has received a communication in the dedicated application and/or indicating that the second user has received an invitation to be a shopping partner for an order.

The user interface 302 includes a control 304 that allows the second user to view additional details about the order. For example, selection of the control 304 can cause the dedicated application to display information on the number of items in the order, a listing of the specific items in the order (to allow the second user to verify accuracy when picking up the order), driving directions to the fulfillment location (e.g., a map and/or turn by turn directions), or additional information on the order. In some implementations, the second user can provide information to change aspects related to the order. For example, in some implementations, the second user can use the dedicated application to change a desired pickup time for the order, change a fulfillment location for the order (e.g., a different location associated with the retailer), or change/specify a fulfillment type for the order (e.g., from a drive-up order to an in-store pickup order). In some implementations, the user interface 302 can include one or more controls that allow the second user to accept or reject the invitation from the first user to be an alternate pick up person for one or more orders. For example, the server system 118 can require that the second user accept the invitation to be an alternate pickup person for an order prior to providing additional details to the second user for the order or before allowing the second user to change aspects of the order.

In some implementations, rather than being displayed by an instance of the dedicated application executing on the mobile device 110, the user interface 302 can be displayed in a web browser, as an email in an email application, as a text message in a messaging application, or as another type of message. For example, the user interface 302 can be displayed in an email accessed by the second user using a dedicated email application executing on the mobile device 110. The second user can select the control 304 to link to a webpage that includes more information on the order and/or allows the second user to change aspects of the order, as described above.

FIG. 3B shows an example in which the second user is not previously registered with the retailer or has an account with retailer registered under a different identifier than that provided by the first user (e.g., the second user is registered with the retailer under a different email address). In this example, the second user receives a message 306, such as an email or text message, at the contact address/phone number provided by the first user as previously described. The message 306 indicates that Ted H. has asked the second user to pick up an order placed with the retailer “Retail-Store.” The message 306 includes a link 308 that the second user to select to cause the mobile device 110 to display a web page in a browser that allows the user to register with the retailer and/or accept the invitation from the first user. For example, the second user can enter name and contact information to register with the retailer. The server system 118 can then use this information to create a profile for the second user and link the profile with the first user's profile and/or one or more orders placed by the first user. The second user may be able to add additional profile information as well, including payment information for future orders or additional shopping partners that are authorized to pick up orders placed by the second user. In some implementations, the second user is required to enter a verification code 310 on a screen displayed in response to selecting the link 308 to verify that the user accepting the invitation to be an alternate pickup person is the person identified by the first user.

In some implementations, such as in a situation in which the second user already has an account with the retailer registered to a different communication address, user name, phone number, etc. than that provided by the first user, the second user can use the verification code 310 to link their account with the retailer with the invitation to be a shopping partner. For example, the second user can select the link 308, which can cause the mobile device 110 to open a webpage in a web browser that permits the second user to log into their account with the retailer. As another example, selecting the link 308 can cause the mobile device 110 to launch the dedicated application associated with the retailer. The dedicated application can then allow the second user to log into their account with the retailer. In some instances, the second user may already be logged into their account through the dedicated application due to previous interactions with the dedicated application. If the login (e.g., email address) associated with the second user's account is different from the login/contact method provided by the first user, the dedicated application (or web page displayed in a browser) can request that the second user enter the verification code 310 displayed in the message 306 to verify that the second user is in fact the person identified by the first user as a requested shopping partner.

FIG. 3C shows a user interface 312 that the second user can use to indicate that they are on their way to pick up an order placed by the first user. For example, the second user can select the control 304 displayed by the user interface 302 in FIG. 3A to cause the dedicated application executing on the mobile device 110 to display details about the order. The second user can then select another control that causes the user interface 312 to be displayed. As another example, the second user can navigate to a menu screen of the dedicated application to review a list of all orders placed by the second user and orders for which the user is identified as an alternate pickup person. In some implementations, the orders placed by the second user are displayed differently than orders for which the second user is an alternate pickup person. For example, orders placed by the second user can be displayed in a first color while orders for which the second user is an alternate pickup person can be displayed using a second color. The second user can select a listing for the order placed by the first user to cause the dedicated application to display user interface 312.

The user interface 312 can include instructions to the second user to indicate when they have begun to travel toward the fulfillment location for the order such as the store 120 and other relevant information, such as store hours for the store 120. The user interface 312 further includes a user selectable icon 314 that allows the second user to indicate that they have begun to travel toward the store 120. Upon selection of the icon 314 by the second user, the mobile device 110 communicates with the server system 118 to indicate that the second user has begun to travel toward the store 120. In some implementations, the server system 118 can determine an estimated time of arrival for the second user based on an initial location for the route to the store 120 (such as the second user's home address, which can be stored as part of the second user's profile information) as described above (e.g., by performing calculations or by communicating with a mapping system). The server system 118 can then communicate with the computing device 122 to notify the employee that the second user is on the way, as described above. This notification can allow the employee to begin gathering items for the order placed by the first user such that the order items can be provided to the second user upon arrival of the second user at the store 120.

In some implementations, in response to the second user opening the dedicated application or in response to the user selecting the icon 314, the dedicated application can request temporary access to location information for the mobile device 110. If the second user permits the dedicated application temporary access to location information (e.g., only while the dedicated application is open), the dedicated application can provide the mobile device 110 location information to the server system 118 to assist the server system 118 in identifying the estimated time of arrival of the user at the store 120. In some implementations, the user interface 312 includes a control 316 that allows the user to change the order fulfillment type. In the example shown in FIG. 3C, the control 316 indicates that the user has selected drive-up order fulfillment and further includes an option to change the order fulfillment type to in-store pickup.

FIG. 3D shows user interface 320 for the mobile device 110 that can be used by the second user to inform one or more employees of the store 120 that they have arrived to pick up the order placed by the first user when the second user (or first user) has selected drive-up fulfillment for the order. The user interface 320 can include instructions to the second user on where to park for drive-up fulfillment and can also provide instructions to prompt the user to indicate when they have arrived. The user interface 320 includes a user selectable control 322 that allows the second user to indicate that they have arrived at the store 120. Upon selection of the control 322 by the second user, the mobile device 110 communicates with the server system 118 to indicate that the second user has arrived at the store 120. In some implementations, the user interface 320 includes a user selectable control 324 that allows the user to view details on the order.

FIG. 3E shows an example user interface 326 that can be displayed in response to a determination that the second user has arrived at the store 120. For example, upon the dedicated application determining that the second user has arrived at the store, the dedicated application displays the user interface 326. As another example, the server system 118 can determine that the second user has arrived at the store 120 and send a communication to the mobile device 110 to cause the mobile device 110 to display the user interface 326. The user interface 326 can include a greeting and information such as an indication that an employee of the store will arrive with the user's order soon. In some implementations, the user interface 326 can include a timer (not shown) that indicates an amount of time since the user has arrived at the store 326. In some implementations, the user interface 326 includes a user selectable control 328 that, when selected, causes the dedicated application to display a verification code, such as a barcode or other optically scannable code, that can be scanned by the employee using the computing device 122 to verify the order.

FIG. 3F shows an example user interface 330 for the second user's mobile device 110 that includes a barcode 332. The user interface 330 having the barcode 332 can be displayed, for example, in response to selection by the user of the control 328 of FIG. 3E or in response to the second user navigating through a menu of the dedicated application. In some implementations, the user interface 330 having the barcode 332 is automatically displayed in response to a determination that the second user has arrived at the store 120. In some implementations, the barcode 332 can be displayed as part of a notification on a lock screen of the mobile device 110. The barcode 332 can be a unique barcode that is associated with the second user. In other implementations, the barcode 332 can be a unique barcode that is associated with the order placed by the first user, or the barcode 332 can be associated with all active orders associated with the second user (e.g., orders for which the second user is a designated alternate pickup person and orders placed by the second user). In such implementations, the barcode 232 can change between each order for the same user. In some implementations, the barcode 232 is tied to a specific payment method. In some implementations, another verification method can be used, such as a matrix barcode, a unique character string, or other unique indicator.

The barcode 232 can be scanned by the employee, e.g., using the computing device 122, to verify the second user's identity and verify that the second user is authorized to pick up the order placed by the first user. For example, if the second user has elected to pick up the order using drive-up fulfillment, the employee can retrieve the bags containing the items for the order from appropriate storage bins (as indicated by the user) and bring the bags out to the user's vehicle. The employee can then scan the barcode 232. For example, the computing device 122 can prompt the employee to scan the barcode 332 displayed on the second user's mobile device 110 using a camera of the computing device 122, an infrared scanner of the computing device 122, or other scanning functionality of the computing device 122. In some implementations, the user computing device 122 can allow the employee to select a mechanism for scanning the barcode 332. In some implementations, the employee can select one or more input buttons of the computing device 122 (e.g., physical buttons or virtual buttons displayed on a touch screen) to scan the barcode 332 using the camera of the computing device 122 and can select one or more other different buttons of the computing device 122 to scan the barcode 332 using the infrared scanner. The barcode 332 can be scanned by the employee using the computing device 122 as part of a drive-up fulfillment process or an in-store pickup fulfillment process.

Upon scanning the barcode 332, the computing device 122 can compare identifying information associated with or conveyed by the barcode 332 to identifying information for the second user or the order to verify the second user's identity and/or to verify that the employee is providing the correct order(s) to the second user. In some implementations, such a determination is made at a central computer of the store 120 in communication with the computing device 122 or at the server system 118.

For example, the barcode 332 can comprise or include a unique identifier for the second user. Upon scanning the barcode 332, the computing device 122 can communicate with the server system 118 to retrieve a list of orders associated with the identifier for the second user. For example, the server system 118 can access a database of orders and identify all orders for which the second user is identified as an alternate pickup person and all orders placed by the second user. The server system 118 communicates this information to the computing device 122 (e.g., via a central computer of the store 120). The computing device 122 then displays information on each of the identified orders that the second user is authorized to pick up to allow the employee to provide the correct orders to the second user. For example, the computing device 122 can display order numbers for the orders. As another example, the computing device 122 can display location information for bags containing the items for the orders (e.g., one or more shelf or bin locations at a drive-up order fulfillment staging area), a number of bags for each order, an indication as to whether or not any of the orders includes age restricted items (e.g., cold medicine, alcohol, etc.), and other information for the orders.

In some implementations, rather than retrieving this order information in response to scanning the barcode 332 (or another optically readable code), this information is retrieved in response to receiving the early described notification that the second user has arrived at the fulfillment location (e.g., the store 120). For example, the server system 118 can receive the notification that the second user has arrived at the store 120 or is about to arrive at the store 120. The server system 118 can then use a unique identifier for the second user to identify all orders for which the second user has placed the order or the second user is an alternate pickup person. For example, the unique identifier for the second user can be associated with a number of orders in an “owner” field or an “alternate pickup person” field. The server system 118 retrieves the relevant information for each of these orders and provides it to the computing device 122 for presentation to the employee to allow the employee to gather the bags for each of the orders and bring them to the second user's vehicle. The employee can then scan the barcode 332 displayed by the second user's mobile device 110 to verify the second user's identity and/or that the second user is authorized to pick up the identified orders. Upon verification, the employee provides the items for the orders to the second user. In some implementations, the computing device 122 can include an interface for collecting a signature from the second user.

In some implementations, a verification code other than a barcode is used, for example, another form of optically scannable code, such as a QR code, can be used in place of the barcode. As another example, a human readable code can be used in place of the bar code. For example, the second user's mobile device 110 can display a numeric or alphanumeric code. The employee can visually read numeric or alphanumeric code displayed on the second user's mobile device 110 and manually enter the numeric or alphanumeric code into a user interface of the computing device 122. All descriptions made with respect to the above example involving the barcode 332 also apply to examples in which a different type of scannable code or a human readable code is displayed by the second user's mobile device 110. For example, a numeric or alphanumeric code displayed by the second user's mobile device 110 and manually entered into the computing device 122 by the employee can be associated with the order, with the alternate pickup person, or with the order owner. As yet another example, the computing device 122 can verify that the second user is authorized to pick up the order by collecting biometric information for the second user, such as a fingerprint or retina scan.

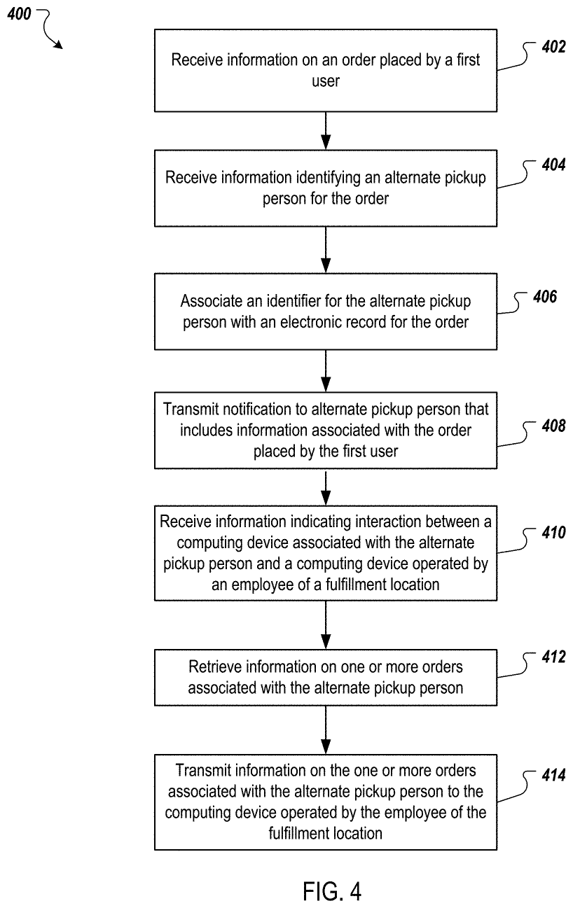

FIG. 4 is a flowchart of an example process 400 to be performed by one or more computing devices in a system for facilitating order pickup by an alternate pickup person. For example, the process 400 can be performed by the server system 118. The steps of the process 400 can be performed in a different order than shown in this example. The process 400 can also include additional steps not shown. The process 400 includes receiving information on an order placed by a first user (402). For example, a user who has an account with a retailer can place an order for one or more items for pickup from a physical store associated with the retailer using a computing device. The information on the order placed by the first user can include items in the order, payment information, and identifying information for the first user (e.g., a username or ID for the first user's account with the retailer).

Information identifying an alternate pickup person for the order is received (404). For example, a username, unique identifier, name, and/or contact information for the alternate pickup person is received. For example, the one or more computing devices can receive an email address for the alternate pickup person provided by the first user. In some implementations, the information identifying the alternate pickup person is provided at the time that the first user places the order and is included along with the information on the order placed by the first user in step 402. In some implementations, the information identifying the alternate pickup person is provided prior to the first user placing the order. For example, the first user can designate the alternate pickup person as being authorized to pick up all orders placed by the first user at a time prior to the first user placing the order. In some implementations, the first user can identify the alternate pickup person as a designated alternate pickup person for the order after placing the order. For example, the first user can review and edit order information after placing the order but prior to fulfillment of the order and identify the alternate pickup person as an alternate pickup person at that point in time.

The process 400 further includes associating an identifier for the alternate pickup person with an electronic record for the order (406). For example, the one or more computing devices can enter a user ID for the alternate pickup person in an “alternate pickup person” field of a database entry for the order. Such a database entry can further include an order ID field and an owner ID field (i.e., identifier for the first user that placed the order). In some implementations, the alternate pickup person is associated with the order by associating a profile for the alternate pickup person with the order. For example, the one or more computing devices can use the received information identifying the alternate pickup person to identify a user profile for the alternate pickup person with the retailer. The one or more computing devices can then associate an identifier included in the profile information for the alternate pickup person with the order. In some implementations, the alternate pickup person cannot be identified using the information identifying the alternate pickup person received at step 404. In such cases, the one or more computing devices can use the received identifying information for the alternate pickup person to contact the alternate pickup person and inform the alternate pickup person that they have been identified as an alternate pickup person for the order. The alternate pickup person can then accept the invitation to become an alternate pickup person. Upon acceptance of the invitation to be an alternate pickup person for the order, the one or more computing devices can create an identifier for the alternate pickup person and associate the identifier with the order.

A notification is transmitted to the alternate pickup person, the notification including information associated with the order placed by the first user (408). For example, the one or more computing devices can transmit information identifying the first user (such as the first user's name, or first name and last initial) along with a fulfillment location and estimated time that the order will be ready for pickup to a computing device associated with the alternate pickup person. The computing device of the alternate pickup person can then display this information to the alternate pickup person to inform the alternate pickup person that they are authorized to pickup the order.

Information indicating interaction between a computing device associated with the alternate pickup person and a computing device operated by an employee of a fulfillment location is received (410). For example, an employee of the fulfillment location can use a computing device to scan an optically readable code displayed by the mobile device of the alternate pickup person. In some implementations, the one or more computing devices communicate information to the mobile device of the alternate pickup person that allows the mobile device of the alternate pickup person to display the optically readable code. In some implementations, the one or more computing devices transmits an image of the optically readable code to the mobile device of the alternate pickup person. In some implementations, the mobile device of the alternate pickup person generates the optically readable code using information received from the one or more computing devices. In some implementations, the employee can read a numeric, alphanumeric, or other code displayed on the mobile device of the alternate pickup person and manually enter the code on the computing device of the fulfillment location. The computing device of the fulfillment location then communicates with the one or more computing devices to provide information identifying the alternate pickup person and indicating that the alternate pickup person has arrived at the fulfillment location.

Information on one or more orders associated with the alternate pickup person is retrieved (412). For example, the one or more computing devices can receive a communication from the computing device of the fulfillment location identifying the alternate pickup person. The one or more computing devices use this information to identify orders in an order database that are associated with the alternate pickup person. This can include all orders that have been placed by the alternate pickup person (e.g., orders for which an identifier for the alternate pickup person is included in an “owner” field) and all orders for which the alternate pickup person is identified as an alternate pickup person (e.g., orders for which an identifier for the alternate pickup person is included in an “alternate pickup person” field).

The process 400 further includes transmitting information on the one or more orders associated with the alternate pickup person to the computing device operated by the employee of the fulfillment location (414). This can include transmitting information such as order numbers for the orders, items included in the orders, identifying information for the alternate pickup person and the first user, location information for bags containing the items for the orders (e.g., one or more shelf or bin locations at a drive-up order fulfillment staging area), a number of bags for each order, an indication as to whether or not any of the orders includes age restricted items (e.g., cold medicine, alcohol, etc.), and other information for the orders. The computing device of the fulfillment location can provide this information to the employee to allow the employee to gather the items for the orders and provide them to the alternate pickup person.

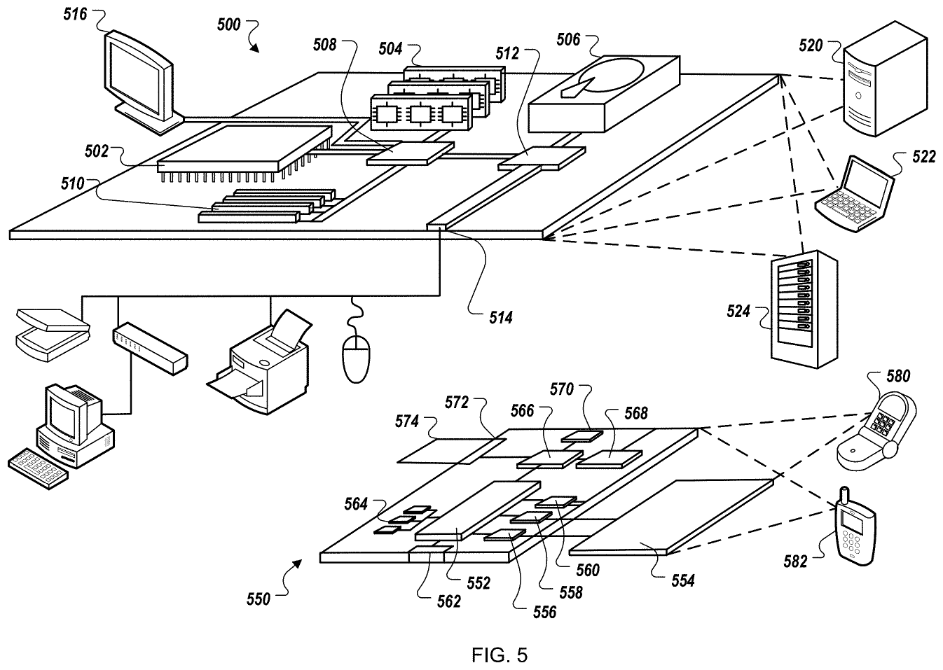

FIG. 5 shows an example of a computing device 500 and an example of a mobile computing device that can be used to implement the techniques described here.

The computing device 500 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The computer program product can also be tangibly embodied in a computer- or machine-readable medium, such as the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is exemplary only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above and may include secure information also. Thus, for example, the expansion memory 574 may be provide as a security module for the mobile computing device 550, and may be programmed with instructions that permit secure use of the mobile computing device 550. In addition, secure applications may be provided via the

SIMM cards, along with additional information, such as placing identifying information on the SIMM card in a non-hackable manner.

The memory may include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 564, the expansion memory 574, or memory on the processor 552. In some implementations, the computer program product can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth, WiFi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor and can be implemented in a high-level procedural and/or object-oriented programming language and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A computer implemented method comprising:
receiving, by at one or more computing devices, a first communication including information for an order for fulfillment at a physical location, the information for the order including indications of one or more items and identifying information for a first user;
receiving, by the one or more computing devices, information including identifying information for an alternate pickup person to be associated with the order, the identifying information for the alternate pickup person having been provided by the first user;
associating an identifier for the alternate pickup person with an electronic record for the order;
transmitting a communication to the alternate pickup person, the communication including information indicating that the first user has authorized the alternate pickup person to pick up the order;
receiving, from a computing device operated by an employee of the physical location, information for verifying the alternate pickup person, the information provided by the computing device associated with the alternate pickup person
retrieving order information for the order in response to receiving the information for verifying the alternate pickup person; and
transmitting the retrieved order information to the computing device operated by the employee of the physical location.

2. The method of claim 1, wherein associating an identifier for the alternate pickup person with an electronic record for the order comprises:
using the identifying information for the alternate pickup person provided by the first user to identify a profile for the alternate pickup person, the profile being a profile associated with a retailer associated with the physical location;
retrieving a unique identifier for the alternate pickup person from the profile for the alternate pickup person; and
entering the unique identifier for the alternate pickup person into an “alternate pickup person” field within the electronic record for the order.

3. The method of claim 1, wherein the electronic record for the order includes a field for an order identifier, a field for an order owner identifier, and at least one field for an alternate pickup person identifier.

4. The method of claim 1, wherein the computing device operated by the employee of the physical location receives the information for verifying the alternate pickup person by scanning an optically readable code displayed by the computing device associated with the alternate pickup person.

5. The method of claim 4, further comprising:
prior to receiving the information for verifying the alternate pickup person, providing information to the computing device associated with the alternate pickup person that allows the computing device associated with the alternate pickup person to display the optically readable code.

6. The method of claim 1, further comprising:
in response to retrieving the order information for the order, transmitting information to the computing device operated by the employee of the physical location indicating that the alternate pickup person is authorized to pick up the order.

7. The method of claim 1, wherein the information for verifying the alternate pickup person comprises a unique identifier for the alternate pickup person.

8. The method of claim 1, further comprising:
retrieving second order information for a second order placed by the alternate pickup person in response to receiving the information for verifying the alternate pickup person; and
transmitting the retrieved second order information to the computing device operated by the employee of the physical location.

9. A system comprising:
one or more processors;
computer memory containing instructions that, when executed by the one or more processors, cause the system to perform operations comprising:
receiving, by at one or more computing devices, a first communication including information for an order for fulfillment at a physical location, the information for the order including indications of one or more items and identifying information for a first user;
receiving, by the one or more computing devices, information including identifying information for an alternate pickup person to be associated with the order, the identifying information for the alternate pickup person having been provided by the first user;
associating an identifier for the alternate pickup person with an electronic record for the order;
transmitting a communication to the alternate pickup person, the communication including information indicating that the first user has authorized the alternate pickup person to pick up the order;
receiving, from a computing device operated by an employee of the physical location, information for verifying the alternate pickup person, the information provided by the computing device associated with the alternate pickup person
retrieving order information for the order in response to receiving the information for verifying the alternate pickup person; and
transmitting the retrieved order information to the computing device operated by the employee of the physical location.

10. The system of claim 9, wherein associating an identifier for the alternate pickup person with an electronic record for the order comprises:
using the identifying information for the alternate pickup person provided by the first user to identify a profile for the alternate pickup person, the profile being a profile associated with a retailer associated with the physical location;
retrieving a unique identifier for the alternate pickup person from the profile for the alternate pickup person; and
entering the unique identifier for the alternate pickup person into an “alternate pickup person” field within the electronic record for the order.

11. The system of claim 9, wherein the electronic record for the order includes a field for an order identifier, a field for an order owner identifier, and at least one field for an alternate pickup person identifier.

12. The system of claim 9, wherein the computing device operated by the employee of the physical location receives the information for verifying the alternate pickup person by scanning an optically readable code displayed by the computing device associated with the alternate pickup person.

13. The system of claim 12, the operations further comprising:
prior to receiving the information for verifying the alternate pickup person, providing information to the computing device associated with the alternate pickup person that allows the computing device associated with the alternate pickup person to display the optically readable code.

14. The system of claim 9, the operations further comprising:
in response to retrieving the order information for the order, transmitting information to the computing device operated by the employee of the physical location indicating that the alternate pickup person is authorized to pick up the order.

15. The system of claim 9, wherein the information for verifying the alternate pickup person comprises a unique identifier for the alternate pickup person.

16. The system of claim, the operations further comprising:
retrieving second order information for a second order placed by the alternate pickup person in response to receiving the information for verifying the alternate pickup person; and
transmitting the retrieved second order information to the computing device operated by the employee of the physical location.

17. A non-transitory computer-readable medium containing instructions that, when executed by one or more processors, cause the performance of operations comprising:
receiving, by at one or more computing devices, a first communication including information for an order for fulfillment at a physical location, the information for the order including indications of one or more items and identifying information for a first user;
receiving, by the one or more computing devices, information including identifying information for an alternate pickup person to be associated with the order, the identifying information for the alternate pickup person having been provided by the first user;
associating an identifier for the alternate pickup person with an electronic record for the order;
transmitting a communication to the alternate pickup person, the communication including information indicating that the first user has authorized the alternate pickup person to pick up the order;
receiving, from a computing device operated by an employee of the physical location, information for verifying the alternate pickup person, the information provided by the computing device associated with the alternate pickup person
retrieving order information for the order in response to receiving the information for verifying the alternate pickup person; and
transmitting the retrieved order information to the computing device operated by the employee of the physical location.

18. The computer-readable medium of claim 17, wherein associating an identifier for the alternate pickup person with an electronic record for the order comprises:
using the identifying information for the alternate pickup person provided by the first user to identify a profile for the alternate pickup person, the profile being a profile associated with a retailer associated with the physical location;
retrieving a unique identifier for the alternate pickup person from the profile for the alternate pickup person; and
entering the unique identifier for the alternate pickup person into an “alternate pickup person” field within the electronic record for the order.

19. The computer-readable medium of claim 17, wherein the electronic record for the order includes a field for an order identifier, a field for an order owner identifier, and at least one field for an alternate pickup person identifier.

20. The computer-readable medium of claim 17, wherein the computing device operated by the employee of the physical location receives the information for verifying the alternate pickup person by scanning an optically readable code displayed by the computing device associated with the alternate pickup person.
